(19) United States
(12) Patent Application Publication
(10) Pub. No.: US 2026/0189740 A1
(43) Pub. Date: Jul. 2, 2026

(54) Measurement System with Frequency Distribution Adjustment Feature

(71) Applicant: The Nielsen Company (US), LLC, New York, NY (US)

(72) Inventors: Joshua Timothy Deragon, Pittsburgh, PA (US); Denis Voytenko, Tampa, FL (US); John Anthony Mann, Clearwater, FL (US)

(21) Appl. No.: 19/089,735

(22) Filed: Mar. 25, 2025

Related U.S. Application Data
(60) Provisional application No. 63/740,146, filed on Dec. 30, 2024.
(60) Provisional application No. 63/764,397, filed on Feb. 27, 2025.

(51) Int. Cl. H04N 21/24; G06Q 30/0201

(52) U.S. Cl. CPC H04N 21/2407; G06Q 30/0201

(57) ABSTRACT

In one aspect, a method involves: determining, by a computing system, an observed distribution that estimates for each of multiple buckets indicating a number of times a given media content item was the subject of a measurement event, a respective count indicating how many people and/or devices were associated with a measurement event of the given media content item that number of times; using at least the observed distribution to determine a first of set of metrics; using at least (i) the determined observed distribution and (ii) at least some of the determined first set of metrics, to determine a reach-adjusted distribution; using at least the determined reach-adjusted distribution to determine a second set of metrics; using at least (i) the determined reach-adjusted distribution and (ii) at least some of the determined second set of metrics, to determine a reach-and-gross-rating-points (GRPs)-adjusted distribution; and outputting for presentation the determined reach-and-GRPs-adjusted distribution.

### CROSS-REFERENCE TO RELATED APPLICATIONS

This application is a non-provisional of, and claims priority to, U.S. Provisional Pat. App. No. 63/740,146 filed Dec. 30, 2024 and U.S. Provisional Pat. App. No. 63/764,397 filed Feb. 27, 2025, both of which are hereby incorporated by reference herein in their entirety.

### USAGE AND TERMINOLOGY

In this disclosure, unless otherwise specified and/or unless the particular context clearly dictates otherwise, the terms “a” or “an” mean at least one, and the term “the” means the at least one.

### SUMMARY

In one aspect, an example method is disclosed. The method includes: determining, by a computing system, an observed frequency distribution that estimates for each of multiple buckets indicating a number of times a given media content item was the subject of a measurement event, a respective count indicating how many people and/or devices were associated with a measurement event of the given media content item that number of times; using, by the computing system, at least the observed frequency distribution to determine a first of set of metrics, wherein the first set of metrics comprises (i) observed metrics derived from the determined observed frequency distribution and (ii) measured metrics comprising at least a portion of the observed metrics, adjusted to account for incomplete observation data; using, by the computing system, at least (i) the determined observed frequency distribution and (ii) at least some of the determined first set of metrics, to determine a reach-adjusted frequency distribution; using, by the computing system, at least the determined reach-adjusted frequency distribution to determine a second set of metrics; using, by the computing system, at least (i) the determined reach-adjusted frequency distribution and (ii) at least some of the determined second set of metrics, to determine a reach-and-gross-rating-points (GRPs)-adjusted distribution; and outputting for presentation, by the computing system, the determined reach-and-GRPs-adjusted frequency distribution.

In one aspect, an example computing system is disclosed. The computing system includes a processor and a non-transitory computer-readable storage medium having stored thereon program instructions that upon execution by the processor, cause the computing system to perform a set of acts including the operation described above in connection with the example method.

In another aspect, an example non-transitory computer-readable medium is disclosed. The computer-readable medium has stored thereon program instructions that upon execution by a processor, cause a computing system to perform a set of acts including the operation described above in connection with the example method.

### BRIEF DESCRIPTION OF THE DRAWINGS

FIG. 1 depicts a simplified block diagram of an example content measurement system in which various described principles can be implemented.

FIG. 2 depicts a simplified block diagram of an example computing system in which various described principles can be implemented.

FIG. 3 depicts frequency distributions and related metrics, in accordance with example embodiments.

FIG. 4 is a flow chart of an example method.

### DETAILED DESCRIPTION

### I. Overview

A content measurement system can measure various types of activity related to content (e.g., media content, such as video content and/or audio content) in various ways. For example, the content measurement system can employ one or more content fingerprinting (sometimes referred to as automatic content recognition or “ACR”) and/or watermarking techniques to measure audience engagement or related activity (e.g., tuning events, viewing events, etc.) in connection with one or more media content items, such as television programs or commercials. In one aspect, this can involve the content measurement system using these and/or other techniques to measure events associated with a given user or device and to generate and/or present corresponding measurement data. Such data relating to a specific user or device is sometimes referred to as respondent level data.

In some examples, the content measurement system can measure many events in connection with a large group of audience members, content-presentation devices, and/or media content items, and can use the measured events as a basis to generate and/or present corresponding aggregated measurement data associated with the audience members, content-presentation devices, and/or media content items.

Such aggregated measurement data can take the form of a frequency distribution, which summarizes data by showing how often each distinct data value of a variable appears in a dataset, essentially grouping responses together and presenting the count of a given category rather than individual respondent level details. For example, in the context of observing measurement events in connection with one or more media content items across one or more users or devices, an observed frequency distribution can provide estimates for each of multiple buckets indicating a number of times a given media content item was the subject of a measurement event, a respective count indicating how many people and/or devices were associated with a measurement event of the given media content item that number of times (e.g., indicating how many people and/or devices were associated with a measurement event of the given media content item zero times, one time, two times, three times, etc.).

In this context, for various reasons, the content measurement system can inadvertently mis-measure events, which can result in inaccurate measurement data. As one example, in the case where the content measurement system uses an ACR system to gather respondent level data, noise or disruption in a media signal can result in the ACR system generating false positive or false negative results. This can result in inaccurate respondent level data, which in turn can result in inaccurate frequency distributions generated based on that respondent level data.

The content management system can identify such inaccuracies in various ways. For example, it can do so by obtaining respondent level data in different ways and then comparing the results of both datasets. For example, in addition to obtaining observed data using an ACR system, the content measurement system can additionally obtain data about the same people and/or devices (or at least a representative portion thereof) based on panel data or the like, which in some examples, can be more accurate than the ACR data as described above.

In one possible example, with the assumption that the panel data is considered the truth or at least the most accurate data, the content measurement system can compare a given set of ACR data with a corresponding set of panel data and use any determined differences as a basis to determine an extent of the inaccuracy of the ACR data. As part of this, the content measurement system can determine what sort of adjustment should be made to the ACR data to account for the inaccuracies, and can then make such adjustments in an effort to improve the accuracy of the ACR data. The content management system can do this using an additive reach adjustment, gross ratings point (GRP) adjustment, or similar conventional techniques.

However, such techniques often provide undesirable results in that they often struggle to account for all aspects of the data when the data is being adjusted. Indeed, with these conventional approaches, within the adjusted dataset, the reach (i.e., the number of people and/or devices associated with a measurement event of the given media) may largely be adjusted correctly, but at the expense of the GRP (i.e., the number of times a person/or device was associated with a measurement event) not being adjusted properly, or visa-versa.

To address these and other issues, disclosed herein is a content measurement system that includes a frequency distribution adjustment feature that takes an observed frequency distribution (e.g., observed based on ACR data) and adjusts it based on measure data (e.g., measured based on corresponding panel data), with the data being adjusted in a manner that helps preserve the reach, GRP, and general shape of the frequency distribution. Such an adjustment technique provides an improvement over conventional approaches, resulting in a more accurate and useful frequency distribution, which is useful in connection with a variety of practical applications related to media measurement, reporting, etc.

With this approach, in one aspect, the content measurement system can unweight certain measured events to account for any missing/unmeasured events in respondent level data. This can involve the content measurement system applying a special technique to account for the missingness for reach and a separate special technique to account for GRP.

Since these techniques are different, the uplift adjustment to each of them is different. When measuring frequency distributions (counting how many people/devices are associated with a measurement event zero times, one time, two times, etc.), the content measurement system can determine both the reach and the GRPs from the frequency distribution separately from calculating reach and GRPs from the respondent level data directly.

In one aspect, the content measurement system can determine reach by summing together the counts for each bucket in the frequency distribution greater than or equal to 1. The measurement system can calculate the GRPs by taking the sum-product of all the buckets and corresponding counts. Ensuring that the frequency distribution can recreate the calculated reach and GRPs acts as a quality check of all three measurements and ensures consistency between reported metrics.

These techniques help solve the inaccuracies noted above by first, iteratively adjusting the frequency buckets by the percent difference of the reach calculated from the observed frequency distribution and the calculated, adjusted reach so that the correct, calculated reach is achieved. Then the content measurement system determines the GRPs from the new adjusted frequency distribution and finds the difference to the determined adjusted GRPs to find how many GRPs the content measurement system needs to add or subtract from the frequency distribution in total. Then, based on the distribution percentages of the new adjusted frequency distribution, the content measurement system can iteratively redistribute the GRPs needed to achieve the calculated, adjusted GRP by moving GRPs from one bucket to another.

More generally, in one aspect, the content measurement system can determine an observed frequency distribution that estimates for each of multiple buckets indicating a number of times a given media content item was the subject of a measurement event, a respective count indicating how many people and/or devices were associated with a measurement event of the given media content item that number of times.

Next, the content management system can use at least the observed frequency distribution to determine a first of set of metrics, wherein the first set of metrics includes (i) observed metrics derived from the determined first set of metrics and (ii) measured metrics comprising at least a portion of the observed metrics, adjusted to account for incomplete observation data.

The content management system can then use at least (i) the determined observed frequency distribution and (ii) at least some of the determined first set of metrics, to determine a reach-adjusted frequency distribution. In one aspect, determining the reach-adjusted frequency distribution can involve performing a set of interactive operations, for each of multiple buckets of the reach-adjusted frequency distribution. Then, the content management system can use at least the determined reach-adjusted frequency distribution to determine a second set of metrics.

Next, the content management system can use at least (i) the determined reach-adjusted frequency distribution and (ii) at least some of the determined second set of metrics, to determine a reach-and-GRPs-adjusted distribution. And the content management system can then output for presentation the determined reach-and-GRPs-adjusted frequency distribution. In one aspect, determining the reach-and-GRPs-adjusted frequency distribution can involve performing a set of interactive operations, for each of multiple buckets of the reach-and-GRPs-adjusted frequency distribution.

With this technique, the resulting reach-and-GRPs-adjusted frequency distribution is as a properly adjusted (in view of the measured metrics) version of the observed frequency distribution, while being adjusted in a manner that helps preserve the reach, GRP, and general shape of the observed frequency distribution.

These and other related features, and corresponding example architecture and example operations, will now be described in greater detail.

### II. Example Architecture

### A. Content Measurement System

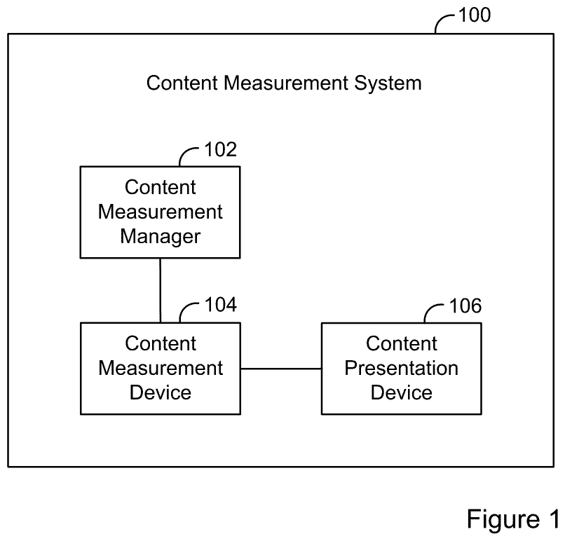

FIG. 1 is a simplified block diagram of an example content measurement system 100. Generally, the content measurement system 100 can perform operations related to measurement of various types of content, such as media content (e.g., video content and/or audio content). As such, the media content can include a video content component and/or an audio content component. There can be various types of media content. For example, media content can be, or include, a movie, a television show, a commercial or other advertisement content, or a portion or combination thereof, among numerous other possibilities.

The content measurement system 100 can include various components, such as a content measurement manager 102, a content measurement device 104, and/or a content presentation device 106. The content measurement system 100 can also include one or more connection mechanisms that connect various components within the content measurement system 100. For example, the content measurement system 100 can include the connection mechanisms represented by lines connecting components of the content measurement system 100, as shown in FIG. 1.

In this disclosure, the term “connection mechanism” means a mechanism that connects and facilitates communication between two or more components, devices, systems, or other entities. A connection mechanism can be or include a relatively simple mechanism, such as a cable or system bus, and/or a relatively complex mechanism, such as a packet-based communication network (e.g., the Internet). In some instances, a connection mechanism can be or include a non-tangible medium, such as in the case where the connection is at least partially wireless. In this disclosure, a connection can be a direct connection or an indirect connection, the latter being a connection that passes through and/or traverses one or more entities, such as a router, switcher, or other network device. Likewise, in this disclosure, a communication (e.g., a transmission or receipt of data) can be a direct or indirect communication.

In some instances, the content measurement system 100 can include multiple instances of at least some of the described components. For example, in practice, the content measurement system 100 is likely to include many content measurement devices 104 and corresponding content presentation devices 106, for many different audience members.

The content measurement system 100 and/or components thereof can take the form of a computing system, an example of which is described below.

### B. Computing System

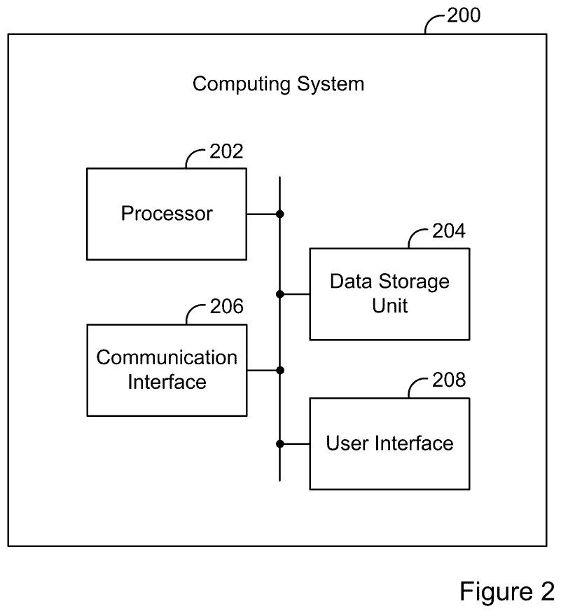

FIG. 2 is a simplified block diagram of an example computing system 200. The computing system 200 can be configured to perform and/or can perform various operations, such as the operations described in this disclosure. The computing system 200 can include various components, such as a processor 202, a data storage unit 204, a communication interface 206, and/or a user interface 208.

The processor 202 can be, or include, a general-purpose processor (e.g., a microprocessor) and/or a special-purpose processor (e.g., a digital signal processor). The processor 202 can execute program instructions included in the data storage unit 204 as described below.

The data storage unit 204 can be or include one or more volatile, non-volatile, removable, and/or non-removable storage components, such as magnetic, optical, and/or flash storage, and/or can be integrated in whole or in part with the processor 202. Further, the data storage unit 204 can be, or include, a non-transitory computer-readable storage medium, having stored thereon program instructions (e.g., compiled or non-compiled program logic and/or machine code) that, upon execution by the processor 202, cause the computing system 200 and/or another computing system to perform one or more operations, such as the operations described in this disclosure. These program instructions can define, and/or be part of, a discrete software application.

In some instances, the computing system 200 can execute program instructions in response to receiving an input, such as an input received via the communication interface 206 and/or the user interface 208. The data storage unit 204 can also store other data, such as any of the data described in this disclosure.

The communication interface 206 can allow the computing system 200 to connect with and/or communicate with another entity according to one or more protocols. Therefore, the computing system 200 can transmit data to, and/or receive data from, one or more other entities according to one or more protocols. In one example, the communication interface 206 can be or include a wired interface, such as an Ethernet interface or a High-Definition Multimedia Interface (HDMI). In another example, the communication interface 206 can be or include a wireless interface, such as a cellular or Wi Fi interface.

The user interface 208 (e.g., a graphical user interface) can allow for interaction between the computing system 200 and a user of the computing system 200. As such, the user interface 208 can be or include an input component such as a keyboard, a mouse, a remote controller, a microphone, and/or a touch sensitive panel. The user interface 208 can also be or include an output component such as a display screen (which, for example, can be combined with a touch sensitive panel and/or a sound speaker.

The computing system 200 can also include one or more connection mechanisms that connect various components within the computing system 200. For example, the computing system 200 can include the connection mechanisms represented by lines that connect components of the computing system 200, as shown in FIG. 2.

The computing system 200 can include one or more of the above-described components and can be configured or arranged in various ways. For example, the computing system 200 can be configured as a server and/or a client (or perhaps a cluster of servers and/or a cluster of clients) operating in one or more server-client type arrangements, such as a partially or fully cloud-based arrangement, for instance.

As noted above, the content measurement system 100 and/or components of the content measurement system 100 can take the form of a computing system, such as the computing system 200. In some cases, some or all of these entities can take the form of a more specific type of computing system, such as a desktop or workstation computer, a laptop, a tablet, a mobile phone, a television, a set-top box, a streaming media device, and/or a head-mountable display device, among numerous other possibilities.

### III. Example Operations

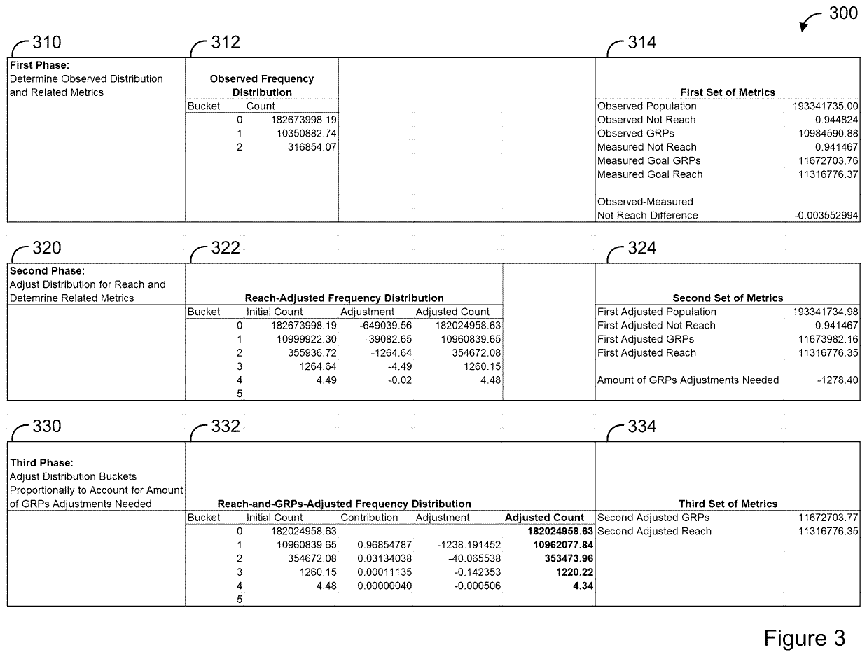

The content measurement system 100, the computing system 200, and/or components of either can be configured to perform and/or can perform various operations, such as those described below. Various operations will be discussed with reference to FIG. 3, which depicts frequency distributions and related metrics 300, in accordance with example embodiments. For explanation purposes, these operations can generally be grouped into four phases, namely a first phase 310, a second phase 320, and a third phase 330, as shown in FIG. 3. It should be noted that the example data, determinations, etc. provided in and/or discussed in connection with FIG. 3 are merely representative examples.

The first phase 310 generally relates to determining an observed frequency distribution and related metrics. To begin, the content measurement manager (“measurement manager” for short) 102 can determine an observed frequency distribution 312 that estimates for each of multiple buckets indicating a number of times a given media content item was the subject of a measurement event, a respective count indicating how many people and/or devices were associated with a measurement event of the given media content item that number of times.

In this context, what is considering a measurement event can be defined to suit a desired configuration. For example, in one example a measurement event can be considered an event in which a media content item is received by a given user's respective content presentation device 106, whereas in another example a measurement event can be considered an event in which a media content item is viewed by a given user (e.g., via the user's content presentation device).

The measurement manager 102 can determine the observed frequency distribution 312 in various ways. For example, measurement manager 102 can determine the observed frequency distribution 312 based on respondent level data obtained using an automatic content recognition technique. In one example, the content measurement device 104 and/or more content presentation devices 106 can include automatic content recognition infrastructure (hardware, software, etc.) that allows the devices to use automatic content recognition technology to obtain respondent level data, which the measurement manager 102 can use to determine the observed frequency distribution 312 using any appropriate techniques now known or later discovered.

The measurement manager 102 can then use at least the observed frequency distribution 312 to determine a first of set of metrics 314. The first set of metrics 314 can include various metrics, which the measurement manager 102 can determine in various ways.

In various examples, the first set of metrics 314 can include observed metrics derived from the determined observed frequency distribution 312, such as (i) an observed population value, (ii) an observed not reach value, and/or (iii) an observed GRPs value, among other values.

The observed population value represents the total number of people/devices that can possibly be reached, within a given dataset. In one example, the measurement manager 102 can determine this by summing together all the counts in the observed frequency distribution.

The observed not reach value represents the ratio of counts in the 0 bucket as compared to the observed population. In one example, the measurement manager 102 can determine this by taking the counts in the 0 bucket and dividing by the observed population.

The observed GRPs value represents the advertising impact associated with the observed frequency distribution 312. In one example, the measurement manager 102 can determine this by taking the sum-product of all the buckets and corresponding counts of the observed frequency distribution 312.

In various examples, the first set of metrics 314 can also include measured metrics such as at least a portion of the observed metrics, adjusted to account for incomplete observation data. For instance, the measured metrics can include (i) a measured not reach value, (ii) a measured goal GRPs value, and/or (iii) a measured goal reach value.

The measured not reach value represents the observed not reach value, adjusted to account for incomplete observation data.

The measured goal GRPs value represents the goal GRPs value to ideally be achieved after the observed GRPs value is adjusted to account for incomplete observation data.

In one example, the measurement manager 102 using at least the observed frequency distribution 312 to determine the first of set of metrics 314 comprises using at least the observed frequency distribution 312 and an additive reach adjustment methodology or other adjustment technique now known or later discovered to determine the measured not reach value and the measured goal GRPs value.

The measured goal reach value represents the goal reach value to ideally be achieved after the observed reach value is adjusted to account for incomplete observation data. In one example, the measurement manager 102 can determine this by subtracting the measured not reach value from 1, and multiplying that result by the observed population value.

In various examples, the first set of metrics 314 can also include an observed-measured not reach difference value. The observed-measured not reach difference value represents a difference between the observed not reach value and the measured not reach value. In one example, the measurement manager 102 can determine this by (i) taking the measured not reach value and subtracting the observed not reach value, and (ii) taking a result of (i) and dividing by the observed not reach value.

The second phase 320 generally relates to adjusting the distribution for reach and determining related metrics. To begin in this phase, the measurement manager 102 can use at least (i) the determined observed frequency distribution 312 and (ii) at least some of the determined first set of metrics 314, to determine a reach-adjusted frequency distribution 322. The measurement manager 102 can do this in various ways. For example, the measurement manager 102 can do this by, for each of multiple buckets of the reach-adjusted frequency distribution 322, determining an initial count value, an adjustment value, and an adjusted count value.

For bucket 0, the measurement manager 102 can determine the initial count by copying the corresponding count (also for bucket 0) of the observed frequency distribution 312.

Also for bucket 0, the measurement manager 102 can determine the adjustment value by taking the initial count and multiplying it by the observed-measured not reach difference value from the first set of metrics 314.

And still for bucket 0, the measurement manager 102 can determine the adjusted count value by taking the initial count value and adding the adjustment value.

For bucket 1, the measurement manager 102 can determine the initial count by taking the corresponding count (also for bucket 1) of the observed frequency distribution 312 and adding the adjustment value corresponding to a next smallest bucket (in this case, bucket 0) of the reach-adjusted frequency distribution 322.

Also for bucket 1, the measurement manager 102 can determine each of the adjustment value and the adjusted count value in the same way as described above with bucket 0 (but adapted for bucket 1). The measurement manager 102 can then repeat this process of determining the initial count value, the adjustment value, and the adjusted count value iteratively for each additional bucket (incrementing the bucket count by 1 each time) until a defined stopping point.

As such, more generally, for all buckets of the reach-adjusted frequency distribution 322 (except bucket 0, which is processed slightly differently as discussed above), the measurement manager 102 using at least (i) the determined observed frequency distribution 312 and (ii) at least some of the determined first set of metrics 314, to determine the reach-adjusted frequency distribution 322 can involve, for each of multiple buckets of the reach-adjusted frequency distribution 322: (i) determining an initial count by taking a corresponding count of the determined observed frequency distribution 312 and subtracting an adjustment value of a next smallest bucket of the determined reach-adjusted frequency distribution 322; (ii) determining an adjustment value by taking the determined initial count and multiplying by an observed-measured not reach difference value of the determined first set of metrics 314; and (iii) determining an adjusted count by taking the determined initial count and adding the determined adjustment value.

As noted above, the measurement manager 102 can iterate in this manner until a defined stopping point. In one example, the defined stopping point can be when the given iteration's determined adjustment value is less than one, as this can signify that less than a single person/device would be moved, which practically speaking, does not further improve the accuracy of the distribution. As such, in one example, for each of multiple buckets of the reach-adjusted frequency distribution 322, the measurement manager 102 can iteratively repeat (i), (ii), and (iii) for each of a next larger bucket until the given iteration's determined adjustment value is less than one.

Next, the measurement manager 102 can use at least the determined reach-adjusted frequency distribution 322 to determine a second set of metrics 324. The second set of metrics 324 can include various metrics, which the measurement manager 102 can determine in various ways.

In various examples, the second set of metrics 324 can include (i) a first adjusted population value, (ii) a first adjusted not reach value, (iii) a first adjusted GRPs value, (iv) a first adjusted reach value, and (v) an amount of GRPs adjustments needed value.

The first adjusted population value represents the total number of people/devices that can possibly be reached (but now based on the adjusted counts of the reach-adjusted frequency distribution 322). In one example, the measurement manager 102 can determine the first adjusted population value by summing together all the counts in the reach-adjusted frequency distribution 322.

The first adjusted not reach value represents the ratio of counts in the 0 bucket as compared to the observed population (but now based on the adjusted counts of the reach-adjusted frequency distribution 322). In one example, the measurement manager 102 can determine this by taking the counts in the 0 bucket and dividing by the first adjusted population value.

The first adjusted GRPs value represents the advertising impact associated with the reach-adjusted frequency distribution 322. In one example, the measurement manager 102 can determine this by taking the sum-product of all the buckets and corresponding counts of the reach-adjusted frequency distribution 322.

The first adjusted reach value represents the reach of the reach-adjusted frequency distribution 322. In one example, the measurement manager 102 can determine this by subtracting the first adjusted not reach value from 1, and multiplying that result by the first adjusted population value.

The second set of metrics 324 can also include the amount of GRPs adjustments needed, which represents the amount of GRPs adjustments needed to account not just for reach adjustments, but also for GRPs adjustments. In one example, the measurement manager 102 can determine this by taking the measured goal GRPs value of the determined first set of metrics 314 and subtracting the first adjusted GRPs value.

The third phase 330 generally relates to adjusting the distribution buckets proportionally to account for the amount of GRPs adjustments needed. To begin in this phase, the measurement manager 102 can use at least (i) the determined reach-adjusted frequency distribution 322 and (ii) at least some of the determined second set of metrics 324, to determine a reach-and-gross-rating-points (GRPs)-adjusted distribution 332.

The measurement manager 102 can do this in various ways. For example, the measurement manager 102 can do this by, for each of multiple buckets of the reach-and-GRPs-adjusted frequency distribution 332, determining (respectively) an initial count value, a contribution value, an adjustment value, and an adjusted count value.

For bucket 0, the measurement manager 102 can determine the initial count by copying the corresponding count (also for bucket 0) of the reach-adjusted frequency distribution 322.

Also for bucket 0, the measurement manager 102 can determine the adjusted count value by copying the initial count value.

For bucket 1, the measurement manager 102 can determine the initial count by copying the corresponding adjusted count (also for bucket 1) of the reach-adjusted frequency distribution 322.

Also for bucket 1, the measurement manager 102 can determine the contribution value by taking the initial count and dividing by the first adjusted reach value of the second set of metrics 324.

Also for bucket 1, the measurement manager 102 can determine the adjustment value by taking the contribution value and dividing by the amount of GRPs adjustment needed of the second set of metrics 324.

And still for bucket 1, the measurement manager 102 can determine the adjusted count value by taking the initial count value and subtracting the adjustment value.

The measurement manager 102 can then repeat this process of determining the initial count value, the contribution value, the adjustment value, and the adjusted count value iteratively for each additional bucket (incrementing the bucket count by 1 each time) until a defined stopping point.

As such, more generally, the measurement manager 102 using at least (i) the determined reach-adjusted frequency distribution 322 and (ii) at least some of the determined second set of metrics 324, to determine the reach-and-GRPs-adjusted frequency distribution 332 can involve, for each of multiple buckets of the reach-and-GRPs-adjusted frequency distribution 332: (i) determining an initial count by taking a corresponding adjusted count of the determined reach-adjusted frequency distribution 322; (ii) determining a contribution value by taking the determined initial count and dividing by a first adjusted reach of the determined second set of metrics 324; (iii) determining an adjustment count by taking the determined contribution value and multiplying by the amount of GRPs adjustments needed value of the determined second set of metrics 324; and (iv) determining an adjusted count value by taking the determined initial count value, adding the determined adjustment value of a next smallest bucket of the determined reach-and-GRPs-adjusted frequency distribution 332, and subtracting the determined adjustment value.

As noted above, the measurement manager 102 can iterate in this manner until a defined stopping point. In one example, the defined stopping point can be when the given iteration's determined adjustment value is less than one, as this can signify that less than a single person/device would be moved, which practically speaking, doesn't further improve the accuracy of the distribution. As such, in one example, for each of multiple buckets of the reach-adjusted frequency distribution, iteratively repeating (i), (ii), (iii), and (iv) for each of a next larger bucket until the given iteration's determined adjustment value is less than one.

By applying this disclosed technique, the resulting reach-and-GRPs-adjusted frequency distribution 332 (specifically, the set of adjusted count values within the reach-and-GRPs-adjusted frequency distribution 332) represents an adjusted version of the observed frequency distribution 312, adjusted in a manner that helps preserve the reach, GRP, and general shape of the observed frequency distribution 312. This can be confirmed in various ways. For example, the measurement manager 102 can use at least the determined reach-and-GRPs-adjusted frequency distribution 332 to determine a third set of metrics 334 that can be used for this purpose. The third set of metrics 334 can include various metrics, which the measurement manager 102 can determine in various ways.

For example, the third set of metrics 334 can include a second adjusted GRPs value and a second adjusted reach value.

The second adjusted GRPs value represents the advertising impact associated with the reach-and-GRPs-adjusted frequency distribution 332. In one example, the measurement manager 102 can determine this by taking the sum-product of all the buckets and corresponding counts of the reach-and-GRPs-adjusted frequency distribution 332.

The second adjusted reach value represents the reach of the reach-and-GRPs-adjusted frequency distribution 332. In one example, the measurement manager 102 can determine this by taking the product sum of all the adjusted count values, except the one for bucket 0.

The measurement manager 102 can then compare the measured goal GRPs of the first set of metrics 314 with the second adjusted GRPs of the third set of metrics 334 and determine whether they have a threshold extent of similarity. Likewise, the measurement manager 102 can compare the measured goal reach of the first set of metrics 314 with the second adjusted reach of the third set of metrics 334 and determine whether they have a threshold extent of similarity. In both instances, the measurement manager 102 can use one or more predefined thresholds, rules, etc., to determine whether the respective pairs of values are sufficiently similar. Based on the measurement manager 102 determining that (i) the measured goal GRPs of the first set of metrics 314 and the second adjusted GRPs of the third set of metrics 334 have a threshold extent of similarity, and (ii) the measured goal reach of the first set of metrics 314 and the second adjusted reach of the third set of metrics 334 have a threshold extent of similarity, the measurement manager 102 can determine that the reach-and-GRPs-adjusted frequency distribution 332 (specifically, the set of adjusted count values within the reach-and-GRPs-adjusted frequency distribution 332) represents an adjusted version of the observed frequency distribution 312, adjusted in a manner that sufficiently preserves the reach, GRP, and general shape of the observed frequency distribution 312, which as noted above, provides an improvement over conventional approaches, resulting in a more accurate and useful frequency distribution.

Notably, in some instances, such as where the amount of GRPs adjustments needed is sufficiently high or low (e.g., based on one or more predefined threshold), the accuracy of the resulting reach-and-GRPs-adjusted frequency distribution 332 can be further improved by dividing the amount of GRPs adjustments needed into multiple batches and performing the entire set of operations described above in connection with phase 3 in an iterative fashion for each of the batches. With this approach, the adjusted count values resulting from operations performed in connection with a given batch (i.e., the output of a given batch) are used as the initial count values in connection with a next batch (i.e., the input of the next batch). Then, in the last batch, the adjusted count values represent the final, adjusted version of the observed frequency distribution 312, adjusted in a manner that helps preserve the reach, GRP, and general shape of the observed frequency distribution 310 as described above.

As such, in some examples, the measurement manager 102 can determine whether the amount of GRPs adjustments needed is below or above and threshold value, and can responsively create batches and perform the batches-related operations as described above. In this context, the measurement manager 102 can continually determine whether the adjusted counts of reach-and-GRPs-adjusted frequency distribution 332 are all greater than zero and if not, the measurement manager 102 can increase the number of batches until that is the case.

The measurement manager 102 can use the determined reach-and-GRPs-adjusted frequency distribution 332 in various ways. For example, the measurement manager 102 can output for presentation the determined reach-and-GRPs-adjusted frequency distribution 332. In one example, this can involve outputting for presentation the determined adjusted count value for each of the multiple buckets of the reach-and-GRPs-adjusted frequency distribution 332.

The measurement manager 102 can additionally or alternatively output for presentation other data, such as any of the distribution values and/or metrics values disclosed herein. The measurement manager 102 can output any such values in various ways, such as by displaying the values via a graphical user interface and/or by transmitting the values to another computing system (where it can be processed, displayed, etc.).

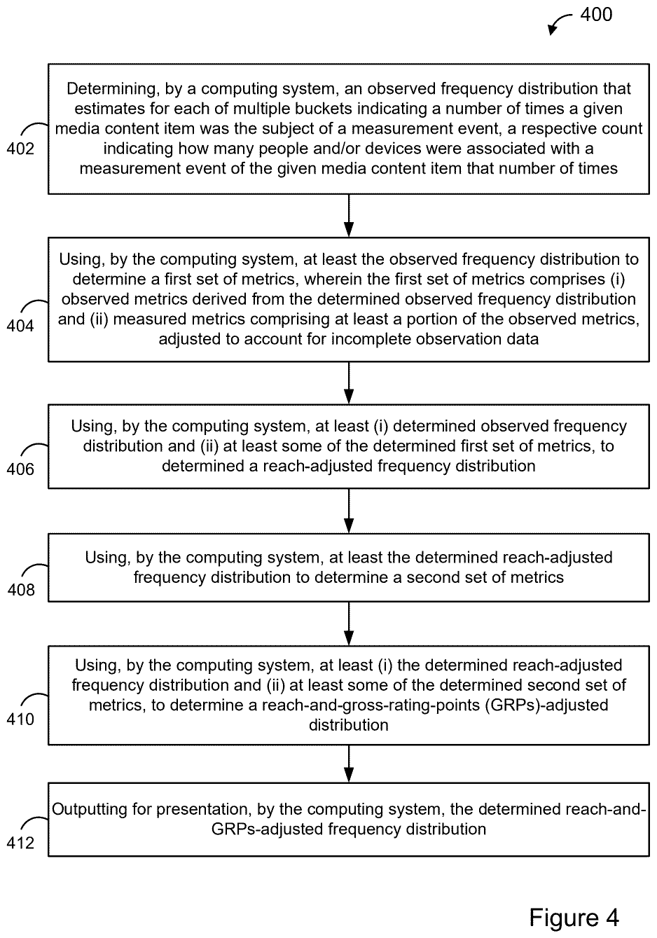

FIG. 4 is a flow chart of an example method 400. At block 402, the method 400 includes determining, by a computing system, an observed frequency distribution that estimates for each of multiple buckets indicating a number of times a given media content item was the subject of a measurement event, a respective count indicating how many people and/or devices were associated with a measurement event of the given media content item that number of times.

At block 404, the method 400 includes using, by the computing system, at least the observed frequency distribution to determine a first of set of metrics, wherein the first set of metrics comprises (i) observed metrics derived from the determined observed frequency distribution and (ii) measured metrics comprising at least a portion of the observed metrics, adjusted to account for incomplete observation data.

At block 406, the method 400 includes using, by the computing system, at least (i) the determined observed frequency distribution and (ii) at least some of the determined first set of metrics, to determine a reach-adjusted frequency distribution.

At block 408, the method 400 includes using, by the computing system, at least the determined reach-adjusted frequency distribution to determine a second set of metrics.

At block 410, the method 400 includes using, by the computing system, at least (i) the determined reach-adjusted frequency distribution and (ii) at least some of the determined second set of metrics, to determine a reach-and-gross-rating-points (GRPs)-adjusted distribution.

At block 412, the method 400 includes outputting for presentation, by the computing system, the determined reach-and-GRPs-adjusted frequency distribution.

In some embodiments, the observed metrics derived from the determined first set of metrics comprises (i) an observed population value, (ii) an observed not reach value, and (iii) an observed GRPs value; the measured metrics comprises (i) a measured not reach value, (ii) a measured goal GRPs value, and (iii) a measured goal reach value; and the first set of metrics further comprises an observed-measured not reach difference value.

In some embodiments, using, by the computing system, at least the observed frequency distribution to determine the first set of metrics comprises using at least the observed frequency distribution and an additive reach adjustment methodology to determine the measured not reach value and the measured goal GRPs value.

In some embodiments, using, by the computing system, at least the observed frequency distribution to determine the first of set of metrics comprises determining the observed-measured not reach difference value by (i) taking the measured not reach value and subtracting the observed not reach value, and (ii) taking a result of (i) and dividing by the observed not reach value.

In some embodiments, using, by the computing system, at least (i) the determined observed frequency distribution and (ii) at least some of the determined first set of metrics, to determine the reach-adjusted frequency distribution comprises: for each of multiple buckets of the reach-adjusted frequency distribution: (i) determining an initial count by taking a corresponding count of the determined observed frequency distribution and subtracting an adjustment value of a next smallest bucket of the determined reach-adjusted frequency distribution; (ii) determining an adjustment value by taking the determined initial count and multiplying by an observed-measured not reach difference value of the determined first set of metrics; and (iii) determining an adjusted count by taking the determined initial count and adding the determined adjustment value.

In some embodiments, for each of multiple buckets of the reach-adjusted frequency distribution, iteratively repeating (i), (ii), and (iii) for each of a next larger bucket until a given iteration's determined adjustment value is less than one.

In some embodiments, the second set of metrics comprises (i) a first adjusted population value, (ii) a first adjusted not reach value, (iii) a first adjusted GRPs value, (iv) a first adjusted reach value, and (v) an amount of GRPs adjustments needed value.

In some embodiments, using, by the computing system, at least the determined reach-adjusted frequency distribution to determine the second set of metrics comprises: determining the amount of GRPs adjustments needed value by taking a measured goal GRPs value of the determined first set of metrics and subtracting the first adjusted GRPs value.

In some embodiments, using, by the computing system, at least (i) the determined reach-adjusted frequency distribution and (ii) at least some of the determined second set of metrics, to determine a reach-and-GRPs-adjusted frequency distribution comprises: for each of multiple buckets of the reach-and-GRPs-adjusted frequency distribution: (i) determining an initial count by taking a corresponding adjusted count of the determined reach-adjusted frequency distribution; (ii) determining a contribution value by taking the determined initial count and dividing by a first adjusted reach of the determined second set of metrics; (iii) determining an adjustment count by taking the determined contribution value and multiplying by an amount of GRPs adjustments needed value of the determined second set of metrics; and (iv) determining an adjusted count value by taking the determined initial count value, adding the determined adjustment value of a next smallest bucket of the determined reach-and-GRPs-adjusted frequency distribution, and subtracting the determined adjustment value.

In some embodiments, outputting for presentation, by the computing system, the determined reach-and-GRPs-adjusted frequency distribution comprises outputting for presentation, by the computing system, the determined adjusted count value for each of the multiple buckets of the reach-and-GRPs-adjusted frequency distribution.

In some embodiments, the method further comprises: using, by the computing system, at least the determined reach-and-GRPs-adjusted frequency distribution to determine a third set of metrics, wherein the third set of metrics comprises (i) a second adjusted GRPs value and (ii) a second adjusted reach value.

In some embodiments, the method further comprises: outputting for presentation, by the computing system, the determined third set of metrics.

In some embodiments, determining the second set of metrics comprises determining an amount of GRPs adjustments needed value, wherein the method further comprises: dividing the determined amount of GRPs adjustments needed value into multiple batches; and performing the using at least (i) the determined reach-adjusted frequency distribution and (ii) at least some of the determined second set of metrics, to determine the reach-and-gross-rating-points (GRPs)-adjusted distribution, in an iterative manner in connection with each of the multiple batches of the determined amount of GRPs adjustments needed value.

In some embodiments, outputting for presentation, by the computing system, the determined reach-and-GRPs-adjusted frequency distribution comprises displaying the determined reach-and-GRPs-adjusted frequency distribution via graphical user interface.

In some embodiments, outputting for presentation, by the computing system, the determined reach-and-GRPs-adjusted frequency distribution comprises transmitting the determined reach-and-GRPs-adjusted frequency distribution to another computing system.

### IV. Example Variations

Although some of the acts and/or functions described in this disclosure have been described as being performed by a particular entity, the acts and/or functions can be performed by any entity, such as those entities described in this disclosure. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects.

1. A method comprising:
determining, by a computing system, an observed frequency distribution that estimates for each of multiple buckets indicating a number of times a given media content item was the subject of a measurement event, a respective count indicating how many people and/or devices were associated with a measurement event of the given media content item that number of times;
using, by the computing system, at least the observed frequency distribution to determine a first of set of metrics, wherein the first set of metrics comprises (i) observed metrics derived from the determined observed frequency distribution and (ii) measured metrics comprising at least a portion of the observed metrics, adjusted to account for incomplete observation data;
using, by the computing system, at least (i) the determined observed frequency distribution and (ii) at least some of the determined first set of metrics, to determine a reach-adjusted frequency distribution;
using, by the computing system, at least the determined reach-adjusted frequency distribution to determine a second set of metrics;
using, by the computing system, at least (i) the determined reach-adjusted frequency distribution and (ii) at least some of the determined second set of metrics, to determine a reach-and-gross-rating-points (GRPs)-adjusted distribution; and
outputting for presentation, by the computing system, the determined reach-and-GRPs-adjusted frequency distribution.

2. The method of claim 1,
wherein the observed metrics derived from the determined first set of metrics comprises (i) an observed population value, (ii) an observed not reach value, and (iii) an observed GRPs value;
wherein the measured metrics comprises (i) a measured not reach value, (ii) a measured goal GRPs value, and (iii) a measured goal reach value; and
wherein the first set of metrics further comprises an observed-measured not reach difference value.

3. The method of claim 2, wherein using, by the computing system, at least the observed frequency distribution to determine the first of set of metrics comprises using at least the observed frequency distribution and an additive reach adjustment methodology to determine the measured not reach value and the measured goal GRPs value.

4. The method of claim 2, wherein using, by the computing system, at least the observed frequency distribution to determine the first of set of metrics comprises determining the observed-measured not reach difference value by (i) taking the measured not reach value and subtracting the observed not reach value, and (ii) taking a result of (i) and dividing by the observed not reach value.

5. The method of claim 1, wherein using, by the computing system, at least (i) the determined observed frequency distribution and (ii) at least some of the determined first set of metrics, to determine the reach-adjusted frequency distribution comprises:
for each of multiple buckets of the reach-adjusted frequency distribution:
(i) determining an initial count by taking a corresponding count of the determined observed frequency distribution and subtracting an adjustment value of a next smallest bucket of the determined reach-adjusted frequency distribution;
(ii) determining an adjustment value by taking the determined initial count and multiplying by an observed-measured not reach difference value of the determined first set of metrics; and
(iii) determining an adjusted count by taking the determined initial count and adding the determined adjustment value.

6. The method of claim 5, further comprising, for each of multiple buckets of the reach-adjusted frequency distribution, iteratively repeating (i), (ii), and (iii) for each of a next larger bucket until a given iteration's determined adjustment value is less than one.

7. The method of claim 1, wherein the second set of metrics comprises (i) a first adjusted population value, (ii) a first adjusted not reach value, (iii) a first adjusted GRPs value, (iv) a first adjusted reach value, and (v) an amount of GRPs adjustments needed value.

8. The method of claim 7, wherein using, by the computing system, at least the determined reach-adjusted frequency distribution to determine the second set of metrics comprises:
determining the amount of GRPs adjustments needed value by taking a measured goal GRPs value of the determined first set of metrics and subtracting the first adjusted GRPs value.

9. The method of claim 1, wherein using, by the computing system, at least (i) the determined reach-adjusted frequency distribution and (ii) at least some of the determined second set of metrics, to determine a reach-and-GRPs-adjusted frequency distribution comprises:
for each of multiple buckets of the reach-and-GRPs-adjusted frequency distribution:
(i) determining an initial count by taking a corresponding adjusted count of the determined reach-adjusted frequency distribution;
(ii) determining a contribution value by taking the determined initial count and dividing by a first adjusted reach of the determined second set of metrics;
(iii) determining an adjustment count by taking the determined contribution value and multiplying by an amount of GRPs adjustments needed value of the determined second set of metrics; and
(iv) determining an adjusted count value by taking the determined initial count value, adding the determined adjustment value of a next smallest bucket of the determined reach-and-GRPs-adjusted frequency distribution, and subtracting the determined adjustment value.

10. The method of claim 9, wherein outputting for presentation, by the computing system, the determined reach-and-GRPs-adjusted frequency distribution comprises outputting for presentation, by the computing system, the determined adjusted count value for each of the multiple buckets of the reach-and-GRPs-adjusted frequency distribution.

11. The method of claim 1, further comprising:
using, by the computing system, at least the determined reach-and-GRPs-adjusted frequency distribution to determine a third set of metrics,
wherein the third set of metrics comprises (i) a second adjusted GRPs value and (ii) a second adjusted reach value.

12. The method of claim 11, further comprising:
outputting for presentation, by the computing system, the determined third set of metrics.

13. The method of claim 1, wherein determining the second set of metrics comprises determining an amount of GRPs adjustments needed value, wherein the method further comprises:
dividing the determined amount of GRPs adjustments needed value into multiple batches; and
performing the using at least (i) the determined reach-adjusted frequency distribution and (ii) at least some of the determined second set of metrics, to determine the reach-and-gross-rating-points (GRPs)-adjusted distribution, in an iterative manner in connection with each of the multiple batches of the determined amount of GRPs adjustments needed value.

14. The method of claim 1, wherein outputting for presentation, by the computing system, the determined reach-and-GRPs-adjusted frequency distribution comprises displaying the determined reach-and-GRPs-adjusted frequency distribution via graphical user interface.

15. The method of claim 1, wherein outputting for presentation, by the computing system, the determined reach-and-GRPs-adjusted frequency distribution comprises transmitting the determined reach-and-GRPs-adjusted frequency distribution to another computing system.

16. A computing system comprising a processor and a non-transitory computer-readable storage medium having stored thereon program instructions that upon execution by the processor, cause the computing system to perform a set of acts comprising:
determining, by the computing system, an observed frequency distribution that estimates for each of multiple buckets indicating a number of times a given media content item was the subject of a measurement event, a respective count indicating how many people and/or devices were associated with a measurement event of the given media content item that number of times;
using, by the computing system, at least the observed frequency distribution to determine a first of set of metrics, wherein the first set of metrics comprises (i) observed metrics derived from the determined observed frequency distribution and (ii) measured metrics comprising at least a portion of the observed metrics, adjusted to account for incomplete observation data;
using, by the computing system, at least (i) the determined observed frequency distribution and (ii) at least some of the determined first set of metrics, to determine a reach-adjusted frequency distribution;
using, by the computing system, at least the determined reach-adjusted frequency distribution to determine a second set of metrics;
using, by the computing system, at least (i) the determined reach-adjusted frequency distribution and (ii) at least some of the determined second set of metrics, to determine a reach-and-gross-rating-points (GRPs)-adjusted distribution; and
outputting for presentation, by the computing system, the determined reach-and-GRPs-adjusted frequency distribution.

17. The computing system of claim 16,
wherein the observed metrics derived from the determined first set of metrics comprises (i) an observed population value, (ii) an observed not reach value, and (iii) an observed GRPs value;
wherein the measured metrics comprises (i) a measured not reach value, (ii) a measured goal GRPs value, and (iii) a measured goal reach value; and
wherein the first set of metrics further comprises an observed-measured not reach difference value.

18. The computing system of claim 17, wherein using, by the computing system, at least the observed frequency distribution to determine the first of set of metrics comprises using at least the observed frequency distribution and an additive reach adjustment methodology to determine the measured not reach value and the measured goal GRPs value.

19. The computing system of claim 17, wherein using, by the computing system, at least the observed frequency distribution to determine the first of set of metrics comprises determining the observed-measured not reach difference value by (i) taking the measured not reach value and subtracting the observed not reach value, and (ii) taking a result of (i) and dividing by the observed not reach value.

20. A non-transitory computer-readable storage medium having stored thereon program instructions that upon execution by a processor, cause a computing system to perform a set of acts comprising:
determining, by the computing system, an observed frequency distribution that estimates for each of multiple buckets indicating a number of times a given media content item was the subject of a measurement event, a respective count indicating how many people and/or devices were associated with a measurement event of the given media content item that number of times;
using, by the computing system, at least the observed frequency distribution to determine a first of set of metrics, wherein the first set of metrics comprises (i) observed metrics derived from the determined observed frequency distribution and (ii) measured metrics comprising at least a portion of the observed metrics, adjusted to account for incomplete observation data;
using, by the computing system, at least (i) the determined observed frequency distribution and (ii) at least some of the determined first set of metrics, to determine a reach-adjusted frequency distribution;
using, by the computing system, at least the determined reach-adjusted frequency distribution to determine a second set of metrics;
using, by the computing system, at least (i) the determined reach-adjusted frequency distribution and (ii) at least some of the determined second set of metrics, to determine a reach-and-gross-rating-points (GRPs)-adjusted distribution; and
outputting for presentation, by the computing system, the determined reach-and-GRPs-adjusted frequency distribution.
